(19) United States
(12) Patent Application Publication
(10) Pub. No.: US 2001/0047049 A1
(43) Pub. Date: Nov. 29, 2001

(54) Process for preparing rubber compositions comprising solid material

(75) Inventors: Manfred Heisler, Emmerting (DE); Helmut Huber, Emmerting (DE); Alois Schlierf, Burghausen (DE); Christoph Schoffel, Burghausen (DE); Johann Schuster, Emmerting (DE)

Correspondence Address: William G. Conger, Brooks & Kushman P.C., 1000 Town Center, 22nd Floor, Southfield, MI, 48075-1351, US

(73) Assignee: Wacker-Chemie GmbH, Munchen (DE)

(21) Appl. No.: 09/862,098

(22) Filed: May 22, 2001

(30) Foreign Application Priority Data
May 25, 2000 (DE) 100 25 872.7

(51) Int. Cl. C08K 3/34; C08K 11/00; C08K 3/04

(52) U.S. Cl. 524/492; 524/495; 524/442

(57) ABSTRACT

The invention relates to a process for preparing rubber compositions which include gas-containing solid material, in which the solid material is compacted by degassing immediately prior to mixing with rubber base polymer.

### BACKGROUND OF THE INVENTION

1. Field of the Invention

The present invention relates to a process for preparing rubber compositions which encompass gas-containing solid material.

2. Background Art

The incorporation of low-bulk-density gas-containing solid materials such as fumed silica or carbon black into rubber compositions, is a difficult process. The solids have a large surface area which is obscured by the gas, and therefore can be wetted only after time-consuming mixing with the base polymers and other constituents of the rubber compositions, since the gas has to be expelled. If the solid material is metered in too rapidly, an uncompacted layer of solid material forms around the walls and mixing vanes or screw in the mixing equipment. This very markedly reduces friction, and prevents achievement of the shear force level needed for mixing. The incorporation of the gas-containing solid materials is therefore an important limiting factor in determining the throughput of any apparatus for preparing rubber compositions.

### SUMMARY OF THE INVENTION

It was an object of the present invention to provide a process for preparing rubber compositions which permits more rapid incorporation of gas-containing solid materials.

### DETAILED DESCRIPTION OF THE PREFERRED EMBODIMENT(S)

The invention provides a process for preparing rubber compositions encompassing gas-containing solid materials, in which the solid material is compacted by degassing immediately prior to mixing with rubber base polymer.

In the process of the invention, the bulk density of the gas-containing solid material is increased at the point of incorporation. The volume incorporated per unit of time is reduced. The incorporation of the solid material therefore takes place more rapidly, substantially accelerating preparation of the rubber compositions, in particular in continuous operations.

Examples of rubber compositions which may be prepared by the process are natural rubber and synthetic rubbers such as synthetic polyisoprene rubber, Buna, SR, SBR, CR, BR, polyurethane rubber, NBR, IIR, BIIR, CO, ECO, CMS, EVA, EVM, PNR, ACM, ANM, FPM, FKM, CFM, PNF, TR, TPR, EDPM, EPM, TRP, and cyclorubber, and silicone rubbers such as HTV, RTV, LSR. The acceleration is particularly advantageous in continuous preparation of HTV silicone rubber compositions, which are usually of high viscosity.

The gas-containing solid material usually comprises a gas which is inert to the solid material and to the constituents of the silicone rubber composition, for example nitrogen, argon, or air. The gas-containing solid material is preferably fluidizable. The gas-containing solid material preferably has a bulk density not greater than 0.4 g/cm³, more preferably not greater than 0.3 g/cm³, and most preferably not greater than 0.2 g/cm³.

Examples of gas-containing solid materials are reinforcing fillers, i.e. fillers with a BET surface area of at least 50 m²/g such as fumed silica, precipitated silica, carbon black, e.g. furnace black and acetylene black, and silicon-aluminum mixed oxides of a large BET surface area, and fibrous fillers such as asbestos and synthetic fibers.

Since the gas-containing solid material is compacted immediately prior to mixing, the transport, conveying, and feeding of the gas-containing solid material can take place in the usual way.

The degassing of the gas-containing solid material may take place by drawing off the gas at reduced pressure, or by mechanical compacting, or a combination of these. Pressure-sensitive solids whose structure can be adversely affected by mechanical forces are preferably compacted by drawing off the gas at reduced pressure. Examples of suitable equipment for degassing at reduced pressure are vacuum screw conveyors. Examples of suitable equipment for mechanical compacting are pressure rollers. Particularly effective degassing takes place using vacuum pressure rollers where compacting takes place at reduced pressure and at the same time mechanically, and the degree of compaction can be regulated via the pressure and also via the rotation rate and the width of the gap between the rollers.

The usual mixing equipment for preparing rubber compositions is suitable for mixing the gas-containing solid materials with rubber base polymer and, where appropriate, with other constituents of the rubber composition. Examples of these are static mixers and dynamic mixers, preferably dynamic mixers, and batch or continuous mixing equipment. Examples of batch mixing equipment are stirrer systems, sigma kneaders, plunger kneaders, mixing rolls, internal mixers, and dissolvers. Examples of continuous mixing equipment are turbine mixers, pressure mixers, and screw kneaders, such as single-screw kneaders, twin-screw kneaders, reciprocating kneaders and Conterna® kneaders.

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

What is claimed is:

1. A process for preparing rubber compositions including gas-containing solid material, comprising compacting the solid material by degassing immediately prior to mixing with rubber base polymer.

2. The process as claimed in claim 1, in which silicone rubber compositions are prepared.

3. The process as claimed in claim 1, in which the gas-containing solid material has a bulk density not above 0.4 g/cm³.

4. The process as claimed in claim 2, in which the gas-containing solid material has a bulk density not above 0.4 g/cm³.

5. The process of claims 1, wherein degassing of the gas-containing solid material takes place by drawing off the gas at reduced pressure.

6. The process of claims 2, wherein degassing of the gas-containing solid material takes place by drawing off the gas at reduced pressure.

7. The process of claims 3, wherein degassing of the gas-containing solid material takes place by drawing off the gas at reduced pressure.

8. The process of claims 4, wherein degassing of the gas-containing solid material takes place by drawing off the gas at reduced pressure.

9. The process of claims 1, wherein degassing of the gas-containing solid material takes place by mechanical compacting.

10. The process of claims 2, wherein degassing of the gas-containing solid material takes place by mechanical compacting.

11. The process of claims 3, wherein degassing of the gas-containing solid material takes place by mechanical compacting.

12. The process of claims 5, wherein degassing of the gas-containing solid material takes place by mechanical compacting.

13. The process of claim 1, wherein degassing takes place employing a vacuum pressure roller.

14. The process of claim 2, wherein degassing takes place employing a vacuum pressure roller.

15. The process of claim 3, wherein degassing takes place employing a vacuum pressure roller.

16. The process of claim 5, wherein degassing takes place employing a vacuum pressure roller.

17. The process of claim 9, wherein degassing takes place employing a vacuum pressure roller.
